(19) United States
(12) Patent Application Publication
(10) Pub. No.: US 2026/0150024 A1
(43) Pub. Date: May 28, 2026

(54) PROCESSING METHOD AND DEVICE FOR SIDELINK CONTINUOUS LISTEN-BEFORE-TALK FAILURE

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/123,420

(22) PCT Filed: Oct. 25, 2022
(86) PCT No.: PCT/CN2022/127432

§ 371 Date: Apr. 23, 2025

(51) Int. Cl. H04W 36/06; H04W 72/40; H04W 76/20; H04W 92/18

(52) U.S. Cl. CPC H04W 36/06; H04W 72/40; H04W 76/20; H04W 92/18

(57) ABSTRACT

A method and apparatus are disclosed for processing sidelink continuous listen-before-talk (LBT) failures in user equipment operating in a wireless communication system. The method includes determining that a currently used resource—such as a resource pool, resource block (RB) set, or activated bandwidth part (BWP)—triggers a sidelink continuous LBT failure, and triggering resource reselection accordingly. In carrier aggregation scenarios, the user equipment selects an alternative resource from the same or another carrier, with preference given to resources on the current carrier unless a threshold number of failures occurs. In non-carrier aggregation scenarios, the resource reselection is limited to the current carrier. If a threshold number of failures is detected across configured resources, the user equipment may trigger a sidelink radio link failure (SL RLF) and notify a higher layer to release all associated sidelink radio resource control (SL-RRC) connections.

### CROSS-REFERENCE TO RELATED APPLICATION

The present application is a U.S. National Stage of International Application No. PCT/CN2022/127432, filed on Oct. 25, 2022, the contents of all of which are incorporated herein by reference in their entirety for all purposes.

### BACKGROUND OF THE INVENTION

In order to support direct communication between user equipment (UE) and user equipment, a sidelink (SL) communication is introduced. There are two modes of transmission resource allocation for sidelink communication: one mode is dynamic scheduling by network, and the other mode is autonomous resource selection by the user equipment in a resource pool broadcasted by network. In the mode of dynamic scheduling by network, a network device dynamically allocates transmission resources for a sidelink to the user equipment according to a cached data report of the user equipment. In the mode of autonomous resource selection, the user equipment randomly selects transmission resource from a resource pool broadcasted or pre-configured by network by itself.

### SUMMARY OF THE INVENTION

The present disclosure relates to the field of communication technology, and in particular to a method and device for processing a sidelink continuous listen before talk failure.

A method for processing a sidelink continuous listen before talk failure (LBT) is provided according to an embodiment of a first aspect of the present disclosure. The method is performed by user equipment and includes: determining that a currently used resource pool triggers a sidelink continuous LBT failure; and triggering resource reselection.

A method for processing a sidelink continuous listen before talk (LBT) failure is provided according to an embodiment of a second aspect of the present disclosure. The method is performed by user equipment and includes: determining that a currently used resource block set (RB set) triggers a sidelink continuous LBT failure; and triggering resource reselection.

A method for processing a sidelink continuous listen before talk failure is provided according to an embodiment of a third aspect of the present disclosure. The method is performed by user equipment and includes: determining that an activated BWP of a current carrier triggers a sidelink continuous listen before talk (LBT) failure; and triggering resource reselection in a case of a carrier aggregation scenario.

A device for processing a sidelink continuous listen before talk (LBT) failure is provided according to an embodiment of a fourth aspect of the present disclosure. The device is applied to user equipment and includes: a first determining module configured to determine that a currently used resource pool triggers a sidelink continuous LBT failure; and a first triggering module configured to trigger resource reselection.

A device for processing a sidelink continuous listen before talk (LBT) failure is provided according to an embodiment of a fifth aspect of the present disclosure. The device is applied to user equipment and includes: a second determining module configured to determine that a currently used RB set triggers a sidelink continuous LBT failure; and a second triggering module configured to trigger resource reselection.

A device for processing a sidelink continuous listen before talk (LBT) failure is provided according to an embodiment of a sixth aspect of the present disclosure. The device is applied to user equipment and includes: a third determining module configured to determine that an activated BWP of a current carrier triggers a sidelink continuous LBT failure; and a third triggering module configured to trigger resource reselection in a case of a carrier aggregation scenario.

A communication device is provided according to an embodiment of a seventh aspect of the present disclosure. The communication device is applied to user equipment and includes: a transceiver; a memory; and one or more processors collectively connected to the transceiver and the memory respectively, where the one or more processors, when collectively executing computer-executable instructions on the memory, are collectively configured to control wireless signal transmission and reception by the transceiver, and to collectively implement the method according to the embodiment of the first aspect or the embodiment of the second aspect or the embodiment of the third aspect of the present disclosure.

A non-transitory computer-readable storage medium is provided according to an embodiment of an eighth aspect of the present disclosure. The non-transitory computer-readable storage medium is applied to user equipment and stores computer-executable instructions, where the computer-executable instructions, when being collectively executed by one or more processors, implement the method according to the embodiment of the first aspect or the embodiment of the second aspect or the embodiment of the third aspect of the present disclosure.

### BRIEF DESCRIPTION OF DRAWINGS

The above and/or additional aspects and advantages of the present disclosure will be apparent and easy to understand from the following description of embodiments made in conjunction with accompanying drawings.

FIG. 1 is a schematic flowchart of a method for processing a sidelink continuous listen before talk failure according to an embodiment of the present disclosure.

FIG. 2 is a schematic flowchart of a method for processing a sidelink continuous listen before talk failure according to an embodiment of the present disclosure.

FIG. 3 is a schematic flowchart of a method for processing a sidelink continuous listen before talk failure according to an embodiment of the present disclosure.

FIG. 4 is a schematic flowchart of a method for processing a sidelink continuous listen before talk failure according to an embodiment of the present disclosure.

FIG. 5 is a schematic flowchart of a method for processing a sidelink continuous listen before talk failure according to an embodiment of the present disclosure.

FIG. 6 is a schematic flowchart of a method for processing a sidelink continuous listen before talk failure according to an embodiment of the present disclosure.

FIG. 7 is a schematic flowchart of a method for processing a sidelink continuous listen before talk failure according to an embodiment of the present disclosure.

FIG. 8 is a block diagram of a device for processing a sidelink continuous listen before talk failure according to an embodiment of the present disclosure.

FIG. 9 is a block diagram of a device for processing a sidelink continuous listen before talk failure according to an embodiment of the present disclosure.

FIG. 10 is a block diagram of a device for processing a sidelink continuous listen before talk failure according to an embodiment of the present disclosure.

FIG. 11 is a schematic structural diagram of a communication device according to an embodiment of the present disclosure.

FIG. 12 is a schematic structural diagram of a chip according to an embodiment of the present disclosure.

### DETAILED DESCRIPTION OF THE INVENTION

The embodiments of the present disclosure will be described in detail below, and instances of the embodiments are shown in the accompanying drawings. Identical or similar reference numerals indicate identical or similar elements or elements having identical or similar functions throughout. The embodiments described below with reference to the accompanying drawings are illustrative and are merely used to explain the present disclosure, but cannot be construed as limitation to the present disclosure. It is to be noted that the embodiments in the present disclosure and features in the embodiments can be combined with one another in a case of no conflict.

Terms used in the embodiments of the present disclosure are merely used to describe embodiments rather than limit the embodiments of the present disclosure. Singular forms such as “a,” “an,” “the” and “this” used in the embodiments and the appended claims of the present disclosure are also intended to include plural forms, unless otherwise clearly stated in the context. It is to be understood that the term “and/or” used in the disclosure indicates and includes any or all possible combinations of one or more of associated listed items.

It is to be understood that although terms such as first, second and third can be used in the embodiments of the present disclosure to describe different types of information, the information is not limited to these terms. These terms are merely used for distinguishing the same type of information from each other. For example, first information can also be referred to as second information and second information can also be referred to as first information similarly without departing from the scope of the embodiments of the present disclosure. Depending on the context, the words such as “if” and “in a case where” as used in the disclosure can be interpreted as “at the time of” or “when” or “in response to determining that”.

In order to facilitate understanding, the terms involved in the embodiments of the present disclosure are introduced at first.

### 1. Sidelink (SL)

A communication interface between user equipment (UE) and user equipment is referred to as a PC-5 interface. On the PC-5 interface, a link between the user equipment and the user equipment for transmitting data is referred to as sidelink. According to a correspondence relation between sending UE and receiving UE, three transmission modes may be supported on the sidelink, that is, unicast, multicast and broadcast. The sending UE transmits sidelink control information (SCI) on a physical sidelink control channel (PSCCH) and transmits second-stage SCI on a physical sidelink shared channel (PSSCH), where a resource location, a source identifier, a target identifier, etc. of transmission data are carried. For a hybrid automatic repeat request (HARQ) feedback enabled data packet, the receiving UE performs HARQ-ACK feedback to the PSSCH on a physical sidelink feedback channel (PSFCH).

### 2. Listen Before Talk (LBT)

The LBT is a type of technology for avoiding channel access conflict. Different pieces of user equipment (UE) compete for shared unlicensed (or license-free) spectrum resources through an LBT operation. The communication protocol release18 (R18) supports use of an unlicensed spectrum by sidelink communication, and the user equipment also needs to perform the LBT when transmitting sidelink data on the unlicensed spectrum. A continuous LBT mechanism is also suitable for the sidelink communication on the unlicensed spectrum.

### 3. Carrier Aggregation (CA)

The carrier aggregation is a key technology in long term evolution-advanced (LTE-A). In order to satisfy requirements for improvements in a single-user peak rate and a system capacity, one of the most straightforward ways is to increase a transmission bandwidth of the system. Thus, the LTE-Advanced system introduces a technology for increasing the transmission bandwidth, that is, carrier aggregation (CA). The CA technology can aggregate a plurality of component carriers (CCs), thus effectively increasing uplink and downlink transmission rates. LTE vehicle to everything (V2X) already supports a technology of sidelink carrier aggregation. R18 new radio (NR) sidelink may also support the technology of sidelink carrier aggregation. That is, the UE communicates with the UE on a plurality of carriers. In this way, resources on a plurality of carriers can be used simultaneously to transmit and receive data, and the transmission rate of the sidelink can be effectively increased.

At present, there are two modes of transmission resource allocation for sidelink communication: one mode is dynamic scheduling by network (model 1), and the other mode is autonomous resource selection by the user equipment in a resource pool broadcasted by network (model 2). Which mode to be used can be configured by a network device through radio resource control (RRC) signaling. In the mode of dynamic scheduling by network, a network device dynamically allocates transmission resources for a sidelink to the user equipment according to a cached data report of the user equipment. In the mode of autonomous resource selection, the user equipment randomly selects transmission resource from a resource pool broadcasted or pre-configured by network by itself. The user equipment needs to select the transmission resource autonomously in a case where the user equipment operates in the mode of autonomous resource selection (mode2). The user equipment will probably become uncertain about how to select the resource once a sidelink continuous listen before talk (LBT) failure is triggered.

In view of that, a method and device for processing a sidelink continuous listen before talk failure are provided according to an embodiment of the present disclosure. For sidelink communication, in a case where the user equipment operates in the mode of autonomous resource selection (mode2) and the sidelink continuous LBT failure is triggered, accuracy of determining how to select a resource by the user equipment can be improved.

The method and device for processing a sidelink continuous listen before talk failure according to the present disclosure will be described in detail with reference to the accompanying drawings.

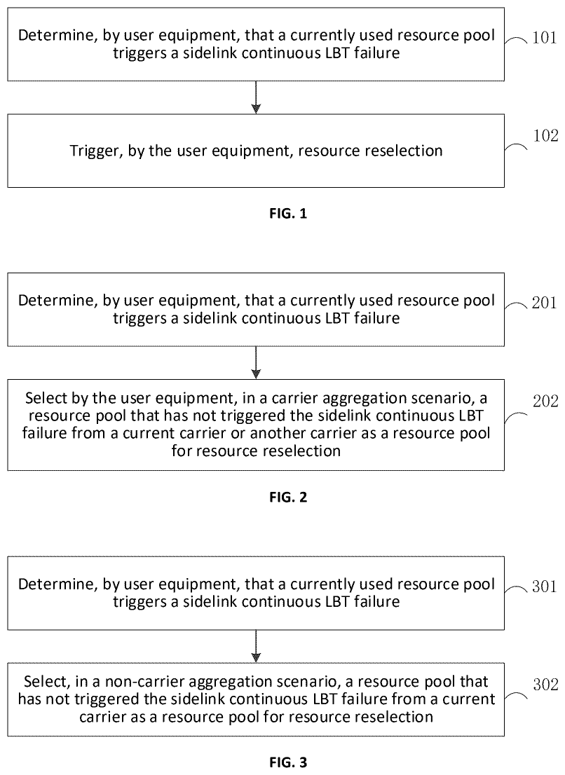

FIG. 1 illustrates a schematic flowchart of a method for processing a sidelink continuous listen before talk (LBT) failure according to an embodiment of the present disclosure. As shown in FIG. 1, the method may be performed by user equipment (UE) and may include steps 101 and 102.

In step 101, it is determined by the user equipment that a currently used resource pool triggers a sidelink continuous LBT failure.

In this embodiment, detection granularity for the sidelink continuous LBT failure is a granularity of resource pool. For example, a number of times of sidelink LBT failures is counted for the currently used resource pool of the user equipment. A network device configures for the user equipment, through radio resource control (RRC) signaling, a corresponding maximum number of times of sidelink continuous LBT failures and a detection timer for the sidelink continuous LBT failure, so as to count the sidelink continuous LBT failure. In a case where the number of times of the sidelink LBT failures for the currently used resource pool is greater than or equal to this maximum number of times within specified time period, it can be determined that the currently used resource pool triggers the sidelink continuous LBT failure.

In step 102, resource reselection is triggered by the user equipment.

By applying the method for processing a sidelink continuous listen before talk failure according to this embodiment, during the user equipment operates in the mode of autonomous resource selection (mode 2), based on the detection granularity of the resource pool, the user equipment may trigger the resource reselection in a case where the currently used resource pool triggers the sidelink continuous LBT failure. Further, a source in another qualified resource pool may be reselected, thus improving the accuracy of determining how to select the resource by the user equipment.

FIG. 2 illustrates a schematic flowchart of a method for processing a sidelink continuous listen before talk failure according to an embodiment of the present disclosure. Based on the embodiment shown in FIG. 1, as shown in FIG. 2, the method may be performed by user equipment and the method may include steps 201 and 202.

In step 201, it is determined by the user equipment that a currently used resource pool triggers a sidelink continuous LBT failure.

In step 202, a resource pool that has not triggered the sidelink continuous LBT failure is selected, in a carrier aggregation scenario, by the user equipment from a current carrier or another carrier as a resource pool for the resource reselection.

In the carrier aggregation scenario, the network device may configure one or more resource pools for the user equipment on an activated bandwidth part (BWP) of each carrier, and the current carrier may be a carrier associated with the currently used resource pool. Before the user equipment transmits data by using each physical sidelink shared channel (PSSCH) or physical sidelink control channel (PSCCH) or physical sidelink feedback channel (PSFCH) resource in these resource pools, an LBT procedure needs to be performed. In a case where the continuous LBT failure is triggered according to the granularity of the resource pool, an LBT failure on any resource in a resource pool may be considered as the LBT failure of the resource pool. In a case where a condition for the continuous LBT failure is satisfied, the user equipment determines that the resource pool triggers the continuous LBT failure. Further, the user equipment may perform the resource reselection on the current carrier or the another carrier, and a resource pool where the reselected resource is located is a resource pool that has not triggered the sidelink continuous LBT failure on the activated BWP of the current carrier or the another carrier. The currently used resource pool may be a resource pool where the currently selected resource is located, and may be one of one or more resource pools configured by the network through dedicated RRC signaling or system information block (SIB). The currently used resource pool may alternatively be one of one or more pre-configured resource pools.

In an implementation, step 202 may include: preferentially selecting, in the carrier aggregation scenario, the resource pool that has not triggered the sidelink continuous LBT failure from the current carrier as the resource pool for the resource reselection; and selecting the resource pool that has not triggered the sidelink continuous LBT failure from the another carrier as the resource pool for the resource reselection in a case where a number of resource pools that have triggered the sidelink continuous LBT failure on the current carrier is greater than or equal to a first preset number. The first preset number may be configured or pre-configured by the network device or determined according to implementation of the user equipment.

For example, the user equipment may preferentially select the resource pool that has not triggered the sidelink continuous LBT failure on the activated BWP of the current carrier for the resource reselection. In this way, resource consumption of cross-carrier processing can be reduced. In a case where more than M resource pools on the activated BWP of the current carrier are detected to trigger the sidelink continuous LBT failure, the user equipment selects a resource pool that has not triggered the sidelink continuous LBT failure on an activated BWP of the another carrier for the resource reselection. M may be configured or pre-configured by the network device or determined according to the implementation of the user equipment. M is a positive integer greater than or equal to 1.

In another implementation, step 202 may further include: randomly selecting, by the user equipment, resource pool from the resource pools that have not triggered the sidelink continuous LBT failure on the current carrier or the another carrier as the resource pool for the resource reselection.

For example, in the carrier aggregation scenario, in a case where a currently used resource pool A triggers the sidelink continuous LBT failure, the user equipment selects another resource pool B that has not triggered the sidelink continuous LBT failure from the current carrier or the another carrier as the resource pool for the resource reselection. In a case where the reselected resource pool B is detected to trigger the sidelink continuous LBT failure later, the user equipment cannot reselects a source of the resource pool A, but may select yet another resource pool C that has not triggered the sidelink continuous LBT failure from the current carrier or the another carrier instead as the resource pool for the resource reselection.

Further, in the carrier aggregation scenario, in a case where a target number of resource pools have triggered the sidelink continuous LBT failure, the user equipment may trigger a sidelink radio link failure (SL RLF), and notify a higher layer to release all associated sidelink radio resource control (SL-RRC) connections. In actual application, the higher layer may be a vehicle to everything (V2X) layer, etc. In the carrier aggregation scenario, the target number may be counted individually or jointly across-carrier according to a granularity of carrier. In the carrier aggregation scenario, the target number may be less than or equal to a total number of resource pools configured on activated BWPs of all activated carriers.

For example, the target number Z is a positive integer greater than or equal to 1. In the carrier aggregation scenario, Z is equal to the total number of the resource pools configured on the activated BWPs of all the activated carriers. It is to be noted that it is unnecessary to configure Z additionally, and Z may be determined according to a number of configured resource pools. Alternatively, Z may be a positive integer less than the total number of the resource pools configured on the activated BWPs of all the activated carriers. It is to be noted that it is necessary to additionally configure Z, and Z may be configured through dedicated signaling of the network device, or configured for the user equipment by the network device through a system information block (SIB), or obtained through pre-configuration or determined according to the implementation of the user equipment.

For example, in the carrier aggregation scenario, each carrier has respective corresponding target number, and the target number corresponding to each carrier may be identical or not. For example, the target number corresponding to a carrier A is M0. In a case where the user equipment uses a resource in a resource pool on an activated BWP of the carrier A and resource pools over M0 have triggered the sidelink continuous LBT failure, the user equipment may trigger the SL RLF and notify the higher layer to release all associated SL-RRC connections. For example, the target number corresponding to a carrier B is M1. In a case where the user equipment uses a resource in a resource pool on an activated BWP of the carrier B and resource pools over M1 have triggered the sidelink continuous LBT failure, the user equipment may trigger the SL RLF and notify the higher layer to release all associated SL-RRC connections.

For example, in the carrier aggregation scenario, all carriers (for example, three carriers of a carrier A, a carrier B, and a carrier C) have a uniformly counted target number M2, and M2 is less than or equal to a total number of resource pools configured on activated BWPs of all activated carriers. In a case where the carrier A has n1 resource pools that have triggered the sidelink continuous LBT failure, the carrier B has n2 resource pools that have triggered the sidelink continuous LBT failure, and the carrier C has n3 resource pools that have triggered the sidelink continuous LBT failure, and a sum of n1+n2+n3 is greater than or equal to M2, then the user equipment may trigger the SL RLF and notify the higher layer to release all associated SL-RRC connections.

By applying the method for processing a sidelink continuous listen before talk failure according to this embodiment, during the user equipment operates in the mode of autonomous resource selection (mode 2), based on the detection granularity of the resource pool, the user equipment may trigger the resource reselection in a case where the currently used resource pool triggers the sidelink continuous LBT failure. Further, a source in another qualified resource pool may be reselected, thus improving the accuracy of determining how to select the resource by the user equipment.

FIG. 3 illustrates a schematic flowchart of a method for processing a sidelink continuous listen before talk failure according to an embodiment of the present disclosure. Based on the embodiment shown in FIG. 1, as shown in FIG. 3, the method may be performed by user equipment and the method may include steps 301 and 302.

In step 301, it is determined by the user equipment that a currently used resource pool triggers a sidelink continuous LBT failure.

In step 302, a resource pool that has not triggered the sidelink continuous LBT failure is selected, in a non-carrier aggregation scenario, from a current carrier as a resource pool for resource reselection.

The current carrier may be a carrier associated with the currently used resource pool. In the non-carrier aggregation scenario, there are no other carriers except the current carrier. In a case where the user equipment determines that the currently used resource pool has triggered the sidelink continuous LBT failure, the user equipment may perform the resource reselection on the current carrier, and a resource pool where the reselected resource is located is a resource pool that has not triggered the sidelink continuous LBT failure on the activated BWP of the current carrier.

For example, in the non-carrier aggregation scenario, in a case where a currently used resource pool D triggers the sidelink continuous LBT failure, the user equipment selects another resource pool E that has not triggered the sidelink continuous LBT failure from the activated BWP of the current carrier as the resource pool for the resource reselection. In a case where the reselected resource pool E is detected to trigger the sidelink continuous LBT failure later, the user equipment cannot reselects a source of the resource pool D, but may select yet another resource pool F that has not triggered the sidelink continuous LBT failure from the activated BWP of the current carrier instead as the resource pool for the resource reselection.

Further, in the non-carrier aggregation scenario, in a case where a first target number of resource pools have triggered the sidelink continuous LBT failure, the user equipment may trigger an SL RLF and notify a higher layer to release all associated SL-RRC connections. In actual application, the higher layer may be a V2X layer, etc. In the non-carrier aggregation scenario, the first target number may be less than or equal to a total number of resource pools configured on the activated BWPs of the current carrier.

For example, the first target number N is a positive integer greater than or equal to 1. In the non-carrier aggregation scenario, N is equal to the total number of the resource pools configured on the activated BWPs of the current carrier. It is to be noted that it is unnecessary to configure N additionally, and N may be determined according to a number of configured resource pools. Alternatively, N may be a positive integer less than the total number of the resource pools configured on the activated BWPs of the current carrier. It is to be noted that it is necessary to additionally configure N, and N may be configured through dedicated signaling of the network device, or configured for the user equipment by the network device through a system information block (SIB), or obtained through pre-configuration or determined according to the implementation of the user equipment.

In the non-carrier aggregation scenario, in a case where N resource pools on the activated BWPs of the current carrier have triggered the sidelink continuous LBT failure, the user equipment may trigger an SL RLF and notify the higher layer to release all associated SL-RRC connections.

It is to be noted that although the embodiment shown in FIG. 3 is described on the basis of the embodiment shown in FIG. 1, the embodiment shown in FIG. 3 may also be based on the embodiment shown in FIG. 2 similarly, which is not repeated.

By applying the method for processing a sidelink continuous listen before talk failure according to this embodiment, during the user equipment operates in the mode of autonomous resource selection (mode 2), based on the detection granularity of the resource pool, the user equipment may trigger the resource reselection in a case where the currently used resource pool triggers the sidelink continuous LBT failure. Further, a source in another qualified resource pool may be reselected, thus improving the accuracy of determining how to select the resource by the user equipment.

FIG. 4 illustrates a schematic flowchart of a method for processing a sidelink continuous listen before talk failure according to an embodiment of the present disclosure. As shown in FIG. 4, the method may be performed by user equipment and the method may include steps 401 and 402.

In step 401, it is determined by the user equipment that a currently used resource block set (RB set) triggers a sidelink continuous LBT failure.

In this embodiment, a detection granularity for the sidelink continuous LBT failure is a granularity of the RB set. For example, a number of times of sidelink LBT failures is counted for the currently used RB set of the user equipment. A network device configures for the user equipment, through RRC signaling, a corresponding maximum number of times of sidelink continuous LBT failures and a detection timer for the sidelink continuous LBT failure, so as to count the sidelink continuous LBT failure. In a case where the number of times of the sidelink LBT failures for the currently used RB set is greater than or equal to this maximum number of times within specified time period, it can be determined that the currently used RB set triggers the sidelink continuous LBT failure.

In step 402, resource reselection is triggered by the user equipment.

By applying the method for processing a sidelink continuous listen before talk failure according to this embodiment, during the user equipment operates in the mode of autonomous resource selection (mode 2), based on the detection granularity of the RB set, the user equipment may trigger the resource reselection in a case where the currently used RB set triggers the sidelink continuous LBT failure. Further, a source in another qualified RB set may be reselected, thus improving the accuracy of determining how to select the resource by the user equipment.

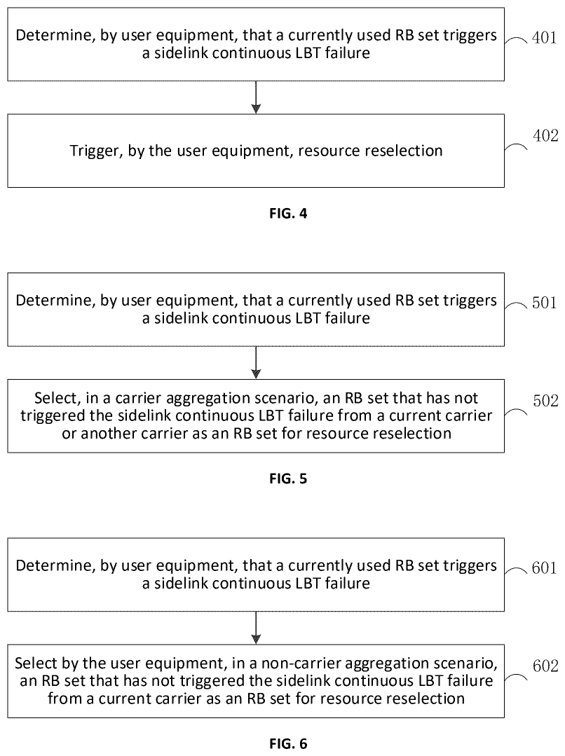

FIG. 5 is a schematic flowchart of a method for processing a sidelink continuous listen before talk failure according to an embodiment of the present disclosure. Based on the embodiment shown in FIG. 4, as shown in FIG. 5, the method may be performed by user equipment and the method may include steps 501 and 502.

In step 501, it is determined by the user equipment that a currently used RB set triggers a sidelink continuous LBT failure.

In step 502, an RB set that has not triggered the sidelink continuous LBT failure is selected, in a carrier aggregation scenario, from a current carrier or another carrier as an RB set for resource reselection.

In the carrier aggregation scenario, the network device may configure one or more RB sets for the user equipment on an activated BWP of each carrier, and the current carrier may be a carrier associated with the currently used RB set. Before the user equipment transmits data by using each PSSCH or PSCCH or PSFCH resource in these RB sets, an LBT procedure needs to be performed. In a case where the continuous LBT failure is triggered according to the granularity of the RB set, an LBT failure on any resource in a RB set may be considered as the LBT failure of the RB set. In a case where a condition for the continuous LBT failure is satisfied, the user equipment determines that the RB set triggers the continuous LBT failure. Further, the user equipment may perform the resource reselection on the current carrier or the another carrier, and an RB set where the reselected resource is located is an RB set that has not triggered the sidelink continuous LBT failure on the activated BWP of the current carrier or the another carrier. The currently used RB set may be an RB set where the currently selected resource is located, and may be one of one or more RB sets configured by the network through dedicated RRC signaling or SIB. The currently used RB set may alternatively be one of one or more pre-configured RB sets.

In an implementation, step 502 may include: preferentially selecting, in the carrier aggregation scenario, the RB set that has not triggered the sidelink continuous LBT failure from the current carrier as the RB set for the resource reselection; and selecting the RB set that has not triggered the sidelink continuous LBT failure from the another carrier as the RB set for the resource reselection in a case where a number of RB sets that have triggered the sidelink continuous LBT failure on the current carrier is greater than or equal to a second preset number. The second preset number may be configured or pre-configured by the network device or determined according to implementation of the user equipment.

For example, the user equipment may preferentially select the RB set that has not triggered the sidelink continuous LBT failure on the activated BWP of the current carrier for the resource reselection. In this way, resource consumption of cross-carrier processing can be reduced. In a case where more than M RB sets on the activated BWP of the current carrier are detected to trigger the sidelink continuous LBT failure, the user equipment selects an RB set that has not triggered the sidelink continuous LBT failure on an activated BWP of the another carrier for the resource reselection. M may be configured or pre-configured by the network device or determined according to the implementation of the user equipment. M is a positive integer greater than or equal to 1.

In another implementation, step 502 may further include: randomly selecting, by the user equipment, RB set from the RB sets that have not triggered the sidelink continuous LBT failure on the current carrier or the another carrier as the RB set for the resource reselection.

For example, in the carrier aggregation scenario, in a case where a currently used RB set A triggers the sidelink continuous LBT failure, the user equipment selects another RB set B that has not triggered the sidelink continuous LBT failure from the current carrier or the another carrier as the RB set for the resource reselection. In a case where the reselected RB set B is detected to trigger the sidelink continuous LBT failure later, the user equipment cannot reselects a source of the RB set A, but may select yet another RB set C that has not triggered the sidelink continuous LBT failure from the current carrier or the another carrier instead as the RB set for the resource reselection.

Further, in the carrier aggregation scenario, in a case where a target number of RB sets have triggered the sidelink continuous LBT failure, the user equipment may trigger an SL RLF and notify a higher layer to release all associated SL-RRC connections. In actual application, the higher layer may be a V2X layer, etc. In the carrier aggregation scenario, the target number may be counted individually or jointly across-carrier according to a granularity of carrier. In the carrier aggregation scenario, the target number may be less than or equal to a total number of RB sets configured on activated BWPs of all activated carriers.

For example, the target number Y is a positive integer greater than or equal to 1. In the carrier aggregation scenario, Y is equal to the total number of the RB sets configured on the activated BWPs of all the activated carriers. It is to be noted that it is unnecessary to configure Y additionally, and Y may be determined according to a number of configured RB sets. Alternatively, Y may be a positive integer less than the total number of the RB sets configured on the activated BWPs of all the activated carriers. It is to be noted that it is necessary to additionally configure Y, and Y may be configured through dedicated signaling of the network device, or configured for the user equipment by the network device through an SIB or obtained through pre-configuration or determined according to the implementation of the user equipment.

For example, in the carrier aggregation scenario, each carrier has respective corresponding target number, and the target number corresponding to each carrier may be identical or not. For example, the target number corresponding to a carrier a is m0. In a case where the user equipment uses a resource in an RB set on an activated BWP of the carrier a and RB sets over m0 have triggered the sidelink continuous LBT failure, the user equipment may trigger the SL RLF and notify the higher layer to release all the associated SL-RRC connections. For example, the target number corresponding to a carrier b is m1. In a case where the user equipment uses a resource in an RB set on an activated BWP of the carrier b and RB sets over m1 have triggered the sidelink continuous LBT failure, the user equipment may trigger the SL RLF and notify the higher layer to release all associated SL-RRC connections.

For example, in the carrier aggregation scenario, all carriers (for example, three carriers of a carrier a, a carrier b, and a carrier c) have a uniformly counted target number m2, and m2 is less than or equal to a total number of RB sets configured on activated BWPs of all activated carriers. In a case where the carrier a has N1 RB sets that have triggered the sidelink continuous LBT failure, the carrier b has N2 RB sets that have triggered the sidelink continuous LBT failure, and the carrier c has N3 RB sets that have triggered the sidelink continuous LBT failure, and a sum of N1+N2+N3 is greater than or equal to m2, then the user equipment may trigger the SL RLF and notify the higher layer to release all the associated SL-RRC connections.

By applying the method for processing a sidelink continuous listen before talk failure according to this embodiment, during the user equipment operates in the mode of autonomous resource selection (mode 2), based on the detection granularity of the RB set, the user equipment may trigger the resource reselection in a case where the currently used RB set triggers the sidelink continuous LBT failure. Further, a source in another qualified RB set may be reselected, thus improving the accuracy of determining how to select the resource by the user equipment.

FIG. 6 is a schematic flowchart of a method for processing a sidelink continuous listen before talk failure according to an embodiment of the present disclosure. Based on the embodiment shown in FIG. 4, as shown in FIG. 6, the method may be performed by user equipment and may include steps 601 and 602.

In step 601, it is determined by the user equipment that a currently used RB set triggers a sidelink continuous LBT failure.

In step 602, an RB set that has not triggered the sidelink continuous LBT failure is selected, in a non-carrier aggregation scenario, by the user equipment from a current carrier as an RB set for resource reselection.

The current carrier may be a carrier associated with the currently used RB set. In the non-carrier aggregation scenario, there are no other carriers except the current carrier. In a case where the user equipment determines that the currently used RB set triggers the sidelink continuous LBT failure, the user equipment may perform the resource reselection on the current carrier, and an RB set where a reselected resource is located is an RB set that has not triggered the sidelink continuous LBT failure on the activated BWP of the current carrier.

For example, in the non-carrier aggregation scenario, in a case where a currently used RB set d triggers the sidelink continuous LBT failure, the user equipment selects another RB set e that has not triggered the sidelink continuous LBT failure from the activated BWP of the current carrier as the RB set for the resource reselection. In a case where the reselected RB set e is detected to trigger the sidelink continuous LBT failure later, the user equipment cannot reselects a source of the RB set d, but may select yet another RB set f that has not triggered the sidelink continuous LBT failure from the activated BWP of the current carrier instead as the RB set for the resource reselection.

Further, in the non-carrier aggregation scenario, in a case where a second target number of RB sets have triggered the sidelink continuous LBT failure, the user equipment may trigger an SL RLF and notify a higher layer to release all associated SL-RRC connections. In actual application, the higher layer may be a V2X layer, etc. In the non-carrier aggregation scenario, the second target number is less than or equal to a total number of RB sets configured on the activated BWPs of the current carrier.

For example, the second target number M is a positive integer greater than or equal to 1. In the non-carrier aggregation scenario, M is equal to a total number of RB sets configured on the activated BWPs of the current carrier. It is to be noted that it is unnecessary to configure M additionally, and M may be determined according to a number of configured RB sets. Alternatively, M may be a positive integer less than the total number of the RB sets configured on the activated BWPs of the current carrier. It is to be noted that it is necessary to additionally configure M, and M may be configured through dedicated signaling of the network device, or configured for the user equipment by the network device through an SIB, or obtained through pre-configuration or determined according to the implementation of the user equipment.

In the non-carrier aggregation scenario, in a case where M RB sets on the activated BWPs of the current carrier have triggered the sidelink continuous LBT failure, the user equipment may trigger an SL RLF and notify the higher layer to release all associated SL-RRC connections.

It is to be noted that although the embodiment shown in FIG. 6 is described on the basis of the embodiment shown in FIG. 4, the embodiment shown in FIG. 6 may also be based on the embodiment shown in FIG. 5 similarly, which is not repeated.

By applying the method for processing a sidelink continuous listen before talk failure according to this embodiment, during the user equipment operates in the mode of autonomous resource selection (mode 2), based on the detection granularity of the RB set, the user equipment may trigger the resource reselection in a case where the currently used RB set triggers the sidelink continuous LBT failure. Further, a source in another qualified RB set may be reselected, thus improving the accuracy of determining how to select the resource by the user equipment.

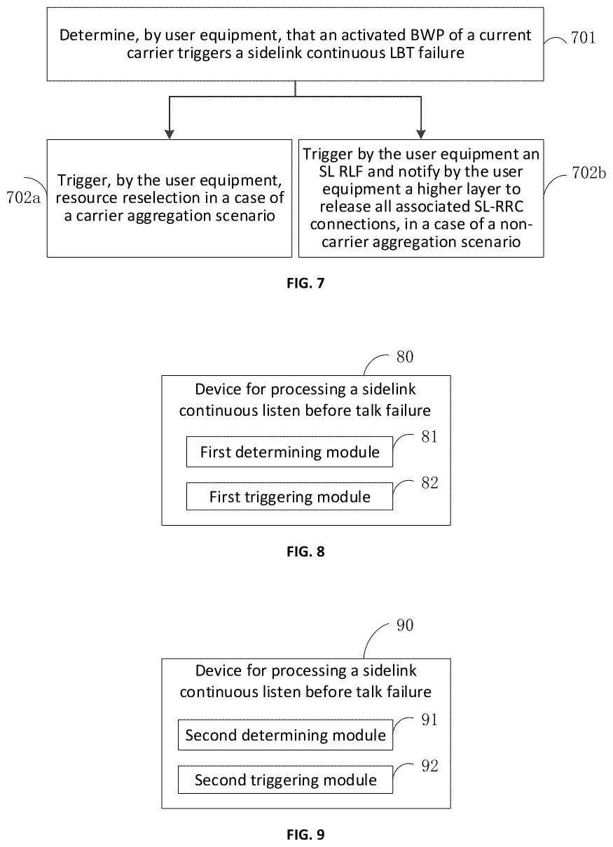

FIG. 7 illustrates a schematic flowchart of a method for processing a sidelink continuous listen before talk failure according to an embodiment of the present disclosure. As shown in FIG. 7, the method may be performed by user equipment and the method may include steps 701, 702a, and 702b.

In step 701, it is determined by the user equipment that an activated BWP of a current carrier triggers a sidelink continuous LBT failure.

In this embodiment, detection granularity for the sidelink continuous LBT failure is a granularity of BWP. A number of times of sidelink LBT failures is counted for the activated BWP of the current carrier of the user equipment. A network device configures for the user equipment, through RRC signaling, a corresponding maximum number of times of sidelink continuous LBT failures and a detection timer for the sidelink continuous LBT failure, so as to count the sidelink continuous LBT failure. In a case where the number of times of the sidelink LBT failures for the activated BWP of the current carrier is greater than or equal to this maximum number of times within a specified time period, it can be determined that the activated BWP of the current carrier triggers the sidelink continuous LBT failure.

For example, the user equipment counts a number of times of uplink LBT failures on each BWP. The network device configures for the user equipment, through RRC signaling (Ibt-FailureRecoveryConfig) according to each serving cell, the maximum number of times (Ibt-FailureInstanceMaxCount) of continuous LBT failures and the detection timer (Ibt-FailureDetectionTimer) for the continuous LBT failure, so as to count the continuous LBT failures. The user equipment maintains an LBT_counter variable for each serving cell, and an initial value of this variable is 0. For each activated service cell configured with lbt-FailureRecoveryConfig, in a case where the user equipment receives an LBT failure indication submitted by a physical layer, the user equipment starts or restarts the lbt-FailureDetectionTimer, and the LBT_counter is increased by 1. In a case where the LBT_counter is greater than or equal to lbt-FailureInstanceMaxCount, the activated BWP in the service cell triggers the continuous LBT failure. In a case where the Ibt-FailureDetectionTimer times out, or the higher layer reconfigures the Ibt-FailureInstanceMaxCount or Ibt-FailureDetectionTimer, or all continuous LBT failures in this service cell are cancelled, the user equipment resets the LBT_counter as 0.

In step 702a, resource reselection is triggered by the user equipment in a case of a carrier aggregation scenario.

In an example, step 702a may include: selecting, in the carrier aggregation scenario, another carrier that has not triggered the sidelink continuous LBT failure as a carrier for the resource reselection.

In a case where the user equipment determines that the activated BWP of the current carrier triggers the sidelink continuous LBT failure, the user equipment may perform resource reselection on the another carrier (different from the current carrier). In an example, the another carrier that has not triggered the sidelink continuous LBT failure may be selected as the carrier for the resource reselection.

For example, in the carrier aggregation scenario, the user equipment performs the resource reselection on the other carriers. The other carriers are carriers that have not triggered the sidelink continuous LBT failure (with the granularity of BWP). In a case where one carrier A triggers the sidelink continuous LBT failure (with the granularity of BWP), the user equipment reselects a resource from another carrier B that has not triggered the sidelink continuous LBT failure. In a case where the reselected carrier B is detected to trigger the sidelink continuous LBT failure (with the granularity of BWP), the user equipment cannot reselect a resource of the carrier A, but may reselect a resource from another carrier C that has not triggered the sidelink continuous LBT failure instead.

Further, in the carrier aggregation scenario, in a case where a third target number of carriers have triggered the sidelink continuous LBT failure, the user equipment may trigger an SL RLF and notify a higher layer to release all associated SL-RRC connections. In actual application, the higher layer may be a V2X layer, etc. The third target number is less than or equal to a total number of activated carriers.

For example, the third target number X is a positive integer greater than or equal to 1. In the carrier aggregation scenario, X is equal to the total number of activated carriers. It is to be noted that it is unnecessary to configure X additionally, and X may be determined according to the total number of activated carriers. Alternatively, X may be a positive integer less than the total number of the activated carriers. It is to be noted that it is necessary to additionally configure X, and X may be configured through dedicated signaling of the network device, or configured for the user equipment by the network device through an SIB, or obtained through pre-configuration or determined according to the implementation of the user equipment.

In the carrier aggregation scenario, in a case where X carriers have triggered the sidelink continuous LBT failure, the user equipment may trigger an SL RLF and notify a higher layer to release all associated SL-RRC connections.

In step 702b, parallel to step 702a, the user equipment may trigger an SL RLF and notify a higher layer to release all associated SL-RRC connections, in a case of a non-carrier aggregation scenario.

In the non-carrier aggregation scenario, there are no other carriers except the current carrier. In a case where the user equipment determines that the activated BWP of the current carrier triggers the sidelink continuous LBT failure, the user equipment may trigger the SL RLF and notify the higher layer to release all associated SL-RRC connections.

By applying the method for processing a sidelink continuous listen before talk failure according to this embodiment, during the user equipment operates in the mode of autonomous resource selection (mode 2), based on the detection granularity of BWP, the user equipment may trigger the resource reselection in a case where the activated BWP of the current carrier triggers the sidelink continuous LBT failure under the carrier aggregation scenario. Further, a source in another qualified carrier may be reselected, thus improving the accuracy of determining how to select the resource by the user equipment. Further, in a case of the non-carrier aggregation scenario, the user equipment may trigger the SL RLF and notify the higher layer to release all associated SL-RRC connections.

In the embodiment according to the present disclosure, the method according to the embodiment of the present disclosure is described from the perspective of the user equipment. In order to perform the functions in the method according to the embodiment of the present disclosure, the user equipment may include a hardware structure and a software module, and the functions are implemented in the form of the hardware structure, the software module, or a combination of the hardware structure and the software module. One of the functions may be performed by the hardware structure, the software module, or the combination of the hardware structure and the software module.

Corresponding to the method for processing a sidelink continuous listen before talk failure according to the several embodiments, a device for processing a sidelink continuous listen before talk failure is further provided by the present disclosure. The device may be applied to user equipment. Since the device for processing a sidelink continuous listen before talk failure according to the embodiment of the present disclosure corresponds to the method for processing a sidelink continuous listen before talk failure according to the embodiments of the present disclosure, an implementation of the method for processing a sidelink continuous listen before talk failure is also applicable to the device for processing a sidelink continuous listen before talk failure according to this embodiment, which will not be described in detail in this embodiment.

FIG. 8 is a schematic structural diagram of a device for processing a sidelink continuous listen before talk failure according to an embodiment of the present disclosure. As shown in FIG. 8, the device 80 may include: a first determining module 81 configured to determine that a currently used resource pool triggers a sidelink continuous LBT failure; and a first triggering module 82 configured to trigger resource reselection.

In some embodiments, the first triggering module 82 is configured to select, in a carrier aggregation scenario, a resource pool that has not triggered the sidelink continuous LBT failure from a current carrier or another carrier as a resource pool for the resource reselection.

In some embodiments, the first triggering module 82 is configured to preferentially select, in the carrier aggregation scenario, the resource pool that has not triggered the sidelink continuous LBT failure from the current carrier as the resource pool for the resource reselection, and select the resource pool that has not triggered the sidelink continuous LBT failure from the another carrier as the resource pool for the resource reselection in a case where a number of resource pools that have triggered the sidelink continuous LBT failure on the current carrier is greater than or equal to a first preset number.

In some embodiments, the first triggering module 82 is configured to select, in a non-carrier aggregation scenario, a resource pool that has not triggered the sidelink continuous LBT failure from a current carrier as a resource pool for the resource reselection.

In some embodiments, the first triggering module 82 is further configured to trigger by the user equipment an SL RLF and notify by the user equipment a higher layer to release all associated SL-RRC connections, in a case where a first target number of resource pools have triggered the sidelink continuous LBT failure. In a non-carrier aggregation scenario, the first target number is less than or equal to a total number of resource pools configured on activated BWPs of a current carrier. In a carrier aggregation scenario, the first target number is less than or equal to a total number of resource pools configured on activated BWPs of all activated carriers.

By applying the solution according to this embodiment, in a case where the user equipment operates in the mode of autonomous resource selection (mode 2), based on detection granularity of the resource pool, the user equipment triggers the resource reselection in a case where the currently used resource pool triggers the sidelink continuous LBT failure. Further, a source on another qualified resource pool may be reselected, thus improving the accuracy of determining how to select the resource by the user equipment.

FIG. 9 is a schematic structural diagram of a device for processing a sidelink continuous listen before talk failure according to an embodiment of the present disclosure. As shown in FIG. 9, the device 90 may include: a second determining module 91 configured to determine that a currently used RB set triggers a sidelink continuous LBT failure; and a second triggering module 92 configured to trigger resource reselection.

In some embodiments, the second triggering module 92 is configured to select, in a carrier aggregation scenario, an RB set that has not triggered the sidelink continuous LBT failure from a current carrier or another carrier as an RB set for the resource reselection.

In some embodiments, the second triggering module 92 is configured to preferentially select, in the carrier aggregation scenario, the RB set that has not triggered the sidelink continuous LBT failure from the current carrier as the RB set for the resource reselection, and select the RB set that has not triggered the sidelink continuous LBT failure from the another carrier as the RB set for the resource reselection in a case where a number of RB sets that have triggered the sidelink continuous LBT failure on the current carrier is greater than or equal to a second preset number.

In some embodiments, the second triggering module 92 is configured to select, in a non-carrier aggregation scenario, an RB set that has not triggered the sidelink continuous LBT failure from a current carrier as an RB set for the resource reselection.

In some embodiments, the second triggering module 92 is further configured to trigger by the user equipment an SL RLF and notify by the user equipment a higher layer to release all associated SL-RRC connections, in a case where a second target number of RB sets have triggered the sidelink continuous LBT failure. In a non-carrier aggregation scenario, the second target number is less than or equal to a total number of RB sets configured on activated BWPs of a current carrier. In a carrier aggregation scenario, the second target number is less than or equal to a total number of RB sets configured on activated BWPs of all activated carriers.

By applying the solution according to this embodiment, in a case where the user equipment operates in the mode of autonomous resource selection (mode 2), based on the detection granularity of the RB set, the user equipment triggers the resource reselection in a case where the currently used RB set triggers the sidelink continuous LBT failure. Further, a source on another qualified RB set may be reselected, thus improving the accuracy of determining how to select the resource by the user equipment.

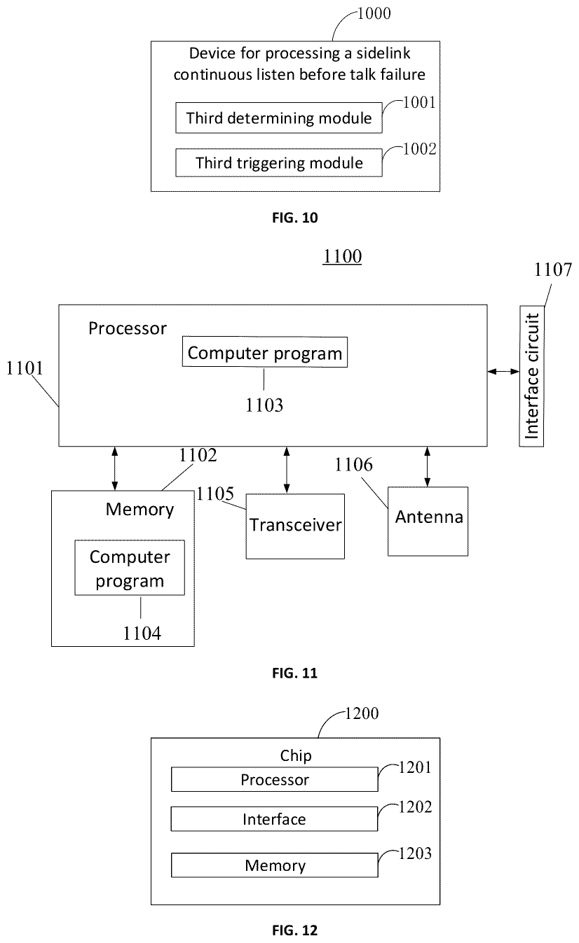

FIG. 10 is a schematic structural diagram of a device for processing a sidelink continuous listen before talk failure according to an embodiment of the present disclosure. As shown in FIG. 10, the device 1000 may include: a third determining module 1001 configured to determine that an activated BWP of a current carrier triggers a sidelink continuous LBT failure; and a third triggering module 1002 configured to trigger resource reselection in a case of a carrier aggregation scenario.

In some embodiments, the third triggering module 1002 is configured to select, in the carrier aggregation scenario, another carrier that has not triggered the sidelink continuous LBT failure as a carrier for the resource reselection.

In some embodiments, the third triggering module 1002 is further configured to trigger by the user equipment an SL RLF and notify by the user equipment a higher layer to release all associated SL-RRC connections, in a case where a third target number of carriers have triggered the sidelink continuous LBT failure under the carrier aggregation scenario. The third target number is less than or equal to a total number of activated carriers.

In some embodiments, the third triggering module 1002 is further configured to trigger by the user equipment an SL RLF and notify by the user equipment a higher layer to release all associated SL-RRC connections, in a case of a non-carrier aggregation scenario.

By applying the solution according to this embodiment, in a case where the user equipment operates in a mode of autonomous resource selection (mode 2), based on detection granularity of the BWP, the user equipment triggers the resource reselection in a case where the activated BWP of the current carrier triggers the sidelink continuous LBT failure under the carrier aggregation scenario. Further, a source on another qualified carrier may be reselected, thus improving the accuracy of determining how to select the resource by the user equipment. The user equipment may trigger an SL RLF and notify the higher layer to release all associated SL-RRC connections, in a case of the non-carrier aggregation scenario.

With reference to FIG. 11, FIG. 11 is a schematic structural diagram of a communication device 1100 according to an embodiment. The communication device 1100 may be applied to the user equipment. The communication device 1100 may be a network device or user equipment, or may be a chip, a chip system or a processor that supports the network device to implement the method, or may be a chip, a chip system, or a processor that supports the user equipment to implement the method. The communication device 1100 may be used to implement the method described in the method embodiment, and reference can be made to the description in the method embodiment for details.

The communication device 1100 may include one or more processors 1101. The processor 1101 may be a general-purpose processor or a special-purpose processor, for example, a baseband processor or a central processing unit. The baseband processor may be configured to process communication protocols and communication data. The central processing unit may be configured to control the communication device 1100 (such as a base station, a baseband chip, user equipment, a user equipment chip, a distributed unit (DU) or a centralized unit (CU)), execute a computer program, and process data of the computer program.

In an example, the communication device 1100 may further include one or more memories 1102. A computer program 1104 may be stored on the memory 1102, and the processor 1101 executes the computer program 1104 so as to cause the communication device 1100 to perform the method described in the method embodiment. In an example, data may also be stored in the memory 1102. The communication device 1100 and the memory 1102 may be set separately or integrated together.

In an example, the communication device 1100 may further include a transceiver 1105 and an antenna 1106. The transceiver 1105 may be referred to as a transceiving unit, a transceiver, a transceiving circuit, etc., and is configured to implement a transceiving function. The transceiver 1105 may include a receiver (not shown) and a transmitter (not shown). The receiver may be referred to as a receiver machine, a receiving circuit, etc., and is configured to implement a receiving function. The transmitter may be referred to as a transmitter or a transmitting circuit, etc., and is configured to implement a transmitting function.

In an example, the communication device 1100 may further include one or more interface circuits 1107. The interface circuit 1107 is configured to receive code instructions and transmit the code instructions to the processor 1101. The processor 1101 runs the code instructions to cause the communication device 1100 to perform the method described in the method embodiment.

In an implementation, the processor 1101 may include a transceiver (not shown) for implementing receiving and transmitting functions. For example, the transceiver may be a transceiving circuit, an interface, or an interface circuit. The transceiving circuit, the interface or the interface circuit for implementing the receiving and transmitting functions may be separated or integrated. The transceiving circuit, the interface or the interface circuit may be used for reading and writing codes/data, or the transceiving circuit, the interface or the interface circuit may be used for signal transmission.

In an implementation, the processor 1101 may store a computer program 1103. The computer program 1103 runs on the processor 1101 so as to cause the communication device 1100 to perform the method described in the method embodiment. The computer program 1103 may be solidified in the processor 1101. In such a case, the processor 1101 may be implemented by hardware.

In an implementation, the communication device 1100 may include a circuit (not shown). The circuit may implement the function of transmitting or receiving or communicating in the method embodiment. The processor 1101 and the transceiver 1105 described in the present disclosure may be implemented on an integrated circuit (IC), an analog IC, a radio frequency integrated circuit (RFIC), a mixed-signal IC, an application specific integrated circuit (ASIC), a printed circuit board (PCB), electronic equipment, etc. The processor 1101 and the transceiver 1105 may alternatively be manufactured by various IC process technologies, such as a complementary metal oxide semiconductor (CMOS), nMetal-oxide-semiconductor (NMOS), a positive channel metal oxide semiconductor (PMOS), a bipolar junction transistor (BJT), bipolar CMOS (BiCMOS), silicon germanium (SiGe), gallium arsenide (GaAs), etc.

The communication device 1100 described in the embodiment may be a network device or user equipment, but the scope of the communication device 1100 described in the present disclosure is not limited to this. The structure of the communication device 1100 may not be limited by FIG. 11. The communication device 1100 may be an independent device or part of a larger device. For example, the communication device 1100 may be:
(1) a separate integrated circuit (IC), a chip, or a chip system or subsystem;
(2) a set with one or more ICs. In an example, the set of ICs may also include a storage component for storing data and computer programs;
(3) an application-specific integrated circuit (ASIC), such as a modem;
(4) a module that is embeddable in other device;
(5) a receiver, user equipment, intelligent user equipment, a cellular phone, a wireless device, a handset, a mobile unit, a vehicle-mounted device, a network device, a cloud device, an artificial intelligence device, etc.; and
(6) others.

For a case where the communication device 1100 may be a chip or a chip system, reference may be made to the schematic structural diagram of a chip shown in FIG. 12. The chip 1200 shown in FIG. 12 includes a processor 1201 and an interface 1202. One or more processors 1201 may be provided, and one or more interfaces 1202 may be provided.

In an example, the chip 1200 further includes a memory 1203. The memory 1203 is configured to store necessary computer programs and data.

Those skilled in the art can also understand that various illustrative logical blocks and steps listed in the embodiments of the present disclosure may be implemented by electronic hardware, computer software, or their combinations. Whether this function is implemented by the hardware or the software depends on a specific application and design requirements from the entire system. Those skilled in the art can use different methods to implement the described functions for each particular application, but such implementation is not considered to fall beyond the protection scope of the embodiment of the present disclosure.

The present disclosure further provides a non-transitory computer-readable storage medium. The non-transitory computer-readable storage medium may be applied to user equipment, and stores instructions. The instructions implement the function of any of the method embodiments when executed by a computer.

The present disclosure further provides a computer program product. The computer program product may be applied to user equipment. The computer program product implements the function of any of the method embodiments when executed by a computer.

The embodiments may be implemented wholly or partially by the software, the hardware, firmware or their combinations. When implemented by the software, the embodiments may be implemented wholly or partially in the form of the computer program product. The computer program product includes one or more computer programs. When the computer program is loaded and executed on the computer, the flows or functions according to the embodiment of the present disclosure is generated wholly or partially. The computer may be a general-purpose computer, a special-purpose computer, a computer network, or another programmable device. The computer program may be stored in a non-transitory computer-readable storage medium or transmitted from one non-transitory computer-readable storage medium to another non-transitory computer-readable storage medium. For example, the computer program may be transmitted from a website, a computer, a server or a data center to another website, computer, server or data by a wired (such as a coaxial cable, an optical fiber, digital subscriber line (DSL)) or wireless (such as infrared, wireless, microwave) method. The non-transitory computer-readable storage medium may be any available media that computers may access or a data storage device such as a server and a data center that includes one or more available media. The available medium may be a magnetic medium (for example, a floppy disk, a hard disk and a magnetic tape), an optical medium (for example, a digital video disc (DVD)), a semiconductor medium (for example, a solid state disk (SSD), etc.

It can be understood by those skilled in the art that the various numerical numbers such as first and second involved in the present disclosure are merely for the convenience of description distinguishing, rather than limiting the scope of the embodiment of this application, and also indicate the sequential order.

The term “at least one” in the present disclosures may also be described as one or more, and the term “plurality” or “more” may indicate two, three, four or more, which is not limited in the present disclosure. In the embodiment of the present disclosure, for a technical feature, technical features in the technical feature are distinguished with “first,” “second,” “third,” “A,” “B,” “C” and “D,” and no sequential order or size order is indicated among the technical features described with “first,” “second,” “third,” “A,” “B,” “C” and “D”.

As used in the disclosure, the terms “machine-readable medium” and “computer-readable medium” refer to any computer program product, device, and/or apparatus (for example, the magnetic disk, the optical disk, memory, the programmable logic device (PLD)) for providing machine instructions and/or data for a programmable processor, and include a machine-readable medium that receives machine instructions as machine-readable signals. The term “machine-readable signal” refers to any signal configured to provide machine instructions and/or data for the programmable processor.

The systems and technologies described in the disclosure may be implemented in a computing system (for example, as a data server) including a backend component, or a computing system (for example, an application server) including a middleware component, or a computing system (for example, a user computer with a graphical user interface or a web browser through which the user may interact with the implementation of the systems and technologies described in the disclosure) including a frontend component, or a computing system including any combination of the backend component, the middleware component, or the frontend component. The components of the system may be connected to each other through digital data communication (for example, a communications network) in any form or medium. Instances of the communication network include a local area network (LAN), the wide area network (WAN) and Internet.

The computer system may include a client and a server. The client and the server are generally far away from each other and usually interact through a communication network. A relation between the client and the server is generated by the computer programs running on corresponding computers and having a client-server relation with each other.

It is to be understood that steps may be rearranged, added or deleted by using the various forms of flow shown in the disclosure. For example, the steps recorded in the present disclosure may be performed in parallel, in order, or in different order, provided that the desired result of the technical solutions disclosed in the present disclosure may be achieved, which is not limited in the disclosure.

In addition, it is to be understood that various embodiments described in the present disclosure can be implemented separately or in combination with other embodiments if allowed by the solution.

It is ready to conceive by those skilled in the art that the units and algorithm steps of the instances described in conjunction with the embodiments disclosed in the disclosure can be implemented by electronic hardware, or a combination of computer software and electronic hardware. Whether these functions are performed by hardware or software depends on the specific application and design constraints of the technical solution. Those skilled in the art can use different methods to implement the described functions for each particular application, but such implementation is not considered to fall beyond the scope of the present disclosure.

Those skilled in the art can clearly understand that for the convenience and conciseness of description, reference can be made to the corresponding processes in the method embodiments for the work processes of the system, device and units, which will not be repeated.

The embodiments of the present disclosure provide the method and device for processing a sidelink continuous listen before talk failure. During the user equipment operates in the mode of autonomous resource selection, based on different detection granularity, the user equipment triggers the resource reselection in a case where the currently used resource pool or the currently used RB set triggers the sidelink continuous LBT failure or in a case where the activated BWP of the current carrier triggers the sidelink continuous LBT failure under the carrier aggregation scenario. Further, another qualified resource pool or another qualified RB set or source on another qualified carriers is reselected, thus improving the accuracy of determining how to select the resource by the user equipment.

The implementations described are merely implementations of the present disclosure, but the protection scope of the present disclosure is not limited to such implementations. Any change or substitution that can be easily conceived by any person of ordinary skill in the art within the technical scope disclosed by the present disclosure falls within the protection scope of the present disclosure. Thus, the protection scope of the present disclosure is subject to the protection scope of the claims.

1. A method for processing a sidelink continuous listen before talk (LBT) failure, performed by user equipment, the method comprising:
determining that a currently used resource pool triggers a sidelink continuous LBT failure; and
triggering resource reselection.

2. The method according to claim 1, wherein triggering the resource reselection comprises:
selecting, in a carrier aggregation scenario, a resource pool that has not triggered the sidelink continuous LBT failure from a current carrier or another carrier as a resource pool for the resource reselection.

3. The method according to claim 2, wherein selecting, in the carrier aggregation scenario, the resource pool that has not triggered the sidelink continuous LBT failure from the current carrier or the another carrier as the resource pool for the resource reselection comprises:
preferentially selecting, in the carrier aggregation scenario, the resource pool that has not triggered the sidelink continuous LBT failure from the current carrier as the resource pool for the resource reselection; and
selecting the resource pool that has not triggered the sidelink continuous LBT failure from the another carrier as the resource pool for the resource reselection in a case where a number of resource pools that have triggered the sidelink continuous LBT failure on the current carrier is greater than or equal to a first preset number.

4. The method according to claim 1, wherein triggering the resource reselection comprises:
selecting, in a non-carrier aggregation scenario, a resource pool that has not triggered the sidelink continuous LBT failure from a current carrier as a resource pool for the resource reselection.

5. The method according to claim 1, further comprising:
triggering by the user equipment a sidelink radio link failure (SL RLF) and notifying by the user equipment a higher layer to release all associated sidelink radio resource control (SL-RRC) connections, in a case where a first target number of resource pools have triggered the sidelink continuous LBT failure;
wherein the first target number is less than or equal to a total number of resource pools configured on activated bandwidth parts (BWPs) of a current carrier in a non-carrier aggregation scenario.

6. A method for processing a sidelink continuous listen before talk (LBT) failure, performed by user equipment, the method comprising:
determining that a currently used resource block set (RB set) triggers a sidelink continuous LBT failure; and
triggering resource reselection.

7. The method according to claim 6, wherein triggering the resource reselection comprises:
selecting, in a carrier aggregation scenario, an RB set that has not triggered the sidelink continuous LBT failure from a current carrier or another carrier as an RB set for the resource reselection.

8. The method according to claim 7, wherein selecting, in the carrier aggregation scenario, the RB set that has not triggered the sidelink continuous LBT failure from the current carrier or the another carrier as the RB set for the resource reselection comprises:
preferentially selecting, in the carrier aggregation scenario, the RB set that has not triggered the sidelink continuous LBT failure from the current carrier as the RB set for the resource reselection; and
selecting the RB set that has not triggered the sidelink continuous LBT failure from the another carrier as the RB set for the resource reselection in a case where a number of RB sets that have triggered the sidelink continuous LBT failure on the current carrier is greater than or equal to a second preset number.

9. The method according to claim 6, wherein triggering the resource reselection comprises:
selecting, in a non-carrier aggregation scenario, an RB set that has not triggered the sidelink continuous LBT failure from a current carrier as an RB set for the resource reselection.

10. The method according to claim 6, further comprising:
triggering by the user equipment a sidelink radio link failure (SL RLF) and notifying by the user equipment a higher layer to release all associated sidelink radio resource control (SL-RRC) connections, in a case where a second target number of RB sets have triggered the sidelink continuous LBT failure;
wherein the second target number is less than or equal to a total number of RB sets configured on activated bandwidth parts (BWPs) of a current carrier in a non-carrier aggregation scenario.

11. A method for processing a sidelink continuous listen before talk (LBT) failure, performed by user equipment, the method comprising:
determining that an activated bandwidth part (BWP) of a current carrier triggers a sidelink continuous LBT failure; and
triggering resource reselection in a case of a carrier aggregation scenario.

12. The method according to claim 11, wherein triggering the resource reselection in a case of the carrier aggregation scenario comprises:
selecting, in the carrier aggregation scenario, another carrier that has not triggered the sidelink continuous LBT failure as a carrier for the resource reselection.

13. The method according to claim 11, further comprising:
triggering by the user equipment a sidelink radio link failure (SL RLF) and notifying by the user equipment a higher layer to release all associated sidelink radio resource control (SL-RRC) connections, in a case where a third target number of carriers have triggered the sidelink continuous LBT failure under the carrier aggregation scenario;
wherein the third target number is less than or equal to a total number of activated carriers.

14. The method according to claim 11, further comprising:
triggering by the user equipment a sidelink radio link failure (SL RLF) and notifying by the user equipment a higher layer to release all associated sidelink radio resource control (SL-RRC) connections, in a case of a non-carrier aggregation scenario.

15.-17. (canceled)

18. A communication device, comprising:
a transceiver;
a memory; and
one or more processors collectively connected to the transceiver and the memory respectively, wherein the one or more processors, when collectively executing computer-executable instructions on the memory, cause the communication device to act as user equipment and perform the method according to claim 1.

19. A non-transitory computer-readable storage medium, storing computer-executable instructions, wherein the computer-executable instructions, when being collectively executed by one or more processors of user equipment, cause the user equipment to perform the method according to claim 1.

20. A communication device, comprising:
a transceiver;
a memory; and
one or more processors collectively connected to the transceiver and the memory respectively, wherein the one or more processors, when collectively executing computer-executable instructions on the memory, cause the communication device to act as user equipment and perform the method according to claim 6.

21. A communication device, comprising:
a transceiver;
a memory; and
one or more processors collectively connected to the transceiver and the memory respectively, wherein the one or more processors, when collectively executing computer-executable instructions on the memory, cause the communication device to act as user equipment and perform the method according to claim 11.

22. A non-transitory computer-readable storage medium, storing computer-executable instructions, wherein the computer-executable instructions, when collectively executed by one or more processors of user equipment, cause the user equipment to perform the method according to claim 6.

23. A non-transitory computer-readable storage medium, storing computer-executable instructions, wherein the computer-executable instructions, when being collectively executed by one or more processors of user equipment, cause the user equipment to perform the method according to claim 11.
